(19) United States
(12) Patent Application Publication
(10) Pub. No.: US 2003/0090509 A1
(43) Pub. Date: May 15, 2003

(54) Methods and systems for exchanging information, such as supplier performance information

(76) Inventors: Ravindra P. Tetambe, Niskayuna, NY (US); Wayne T. Myers, Pittsfield, MA (US)

Correspondence Address: PERKINS COIE LLP, PATENT-SEA, P.O. BOX 1247, SEATTLE, WA, 98111-1247, US

(21) Appl. No.: 09/991,489

(22) Filed: Nov. 15, 2001

(51) Int. Cl. G09G 5/00

(52) U.S. Cl. 345/738

(57) ABSTRACT

Methods and systems for monitoring a global supplier base. In one embodiment, a computer-based system allows a company that contracts with one or more suppliers to obtain performance metrics for those suppliers on a regular basis, such as monthly. These performance metrics can include utilization of manpower, timeliness of deliveries, quality of work, and other similar data. In one embodiment, the method is implemented on general-purpose computers by one or more suppliers who access user interface display pages from a server computer and input performance-related data. This data is then transmitted back to the server computer where it is automatically stored in one or more databases. The contracting company can then access the server computer to obtain the supplier performance data in one or more useful formats.

### TECHNICAL FIELD

The following disclosure relates generally to methods and systems for monitoring suppliers and, more particularly, to computer-implemented methods and systems for exchanging information related to the performance of suppliers in a global supplier base.

### BACKGROUND

Large engineering enterprises and other companies often rely on outside suppliers to provide selected engineering and manufacturing services. These services typically include those tasks that require specialized skills or capacity that the offloading company may lack. Offloading work such as this to outside suppliers has become increasingly important as companies strive to streamline their operations and become more efficient. These outside suppliers, however, are spread all over the globe, and are no longer clustered around the traditional commercial centers of North America and Europe. While a global supplier network may increase the availability of outside services and help to reduce costs, it can also make it difficult for contracting companies to monitor supplier performance.

Monitoring the performance of outside suppliers often presents significant challenges with a global supplier base. The sophisticated nature of the offloaded work, for example, often makes it difficult to assess a supplier's performance during an ongoing project. Further, performance often varies from supplier to supplier depending on the volume and complexity of work, the skills of the workforce, and the digital infrastructure that may exist at the supplier. In addition, implementation of consistent measuring tools is often frustrated by differences in business systems, languages and cultures. Although many suppliers have their own systems for measuring performance, these are often unscientific or incompatible with those of the contracting company.

As a result of these challenges, many companies lack efficient systems for documenting and evaluating the performance of their global supplier base. In response to the lack of such systems, many smaller business groups within these companies often create their own processes for monitoring supplier performance. These processes are usually manually controlled and poorly documented. In addition, these processes are typically tailored for a particular supplier in a particular locale, and thus do not cover aspects of supplier performance that may be relevant to other suppliers in other locales. Such processes also typically rely on paper-based documentation systems that are not conducive to quick retrieval of supplier performance information. These paper-based systems have the further disadvantage of being generally inaccessible to the rest of the company.

For companies that offload substantial amounts of work to a global supplier base, monitoring supplier performance is an important part of their business. Therefore, efficient methods and systems are needed for monitoring global supplier performance.

### BRIEF DESCRIPTION OF THE DRAWINGS

FIG. 1 is a block diagram illustrating components of a supplier performance monitoring system in one embodiment.

FIG. 2 is a flow diagram illustrating a process for providing supplier performance data to a server computer in one embodiment.

FIG. 3 is a flow diagram of a routine for providing a supplier performance report to a user computer in one embodiment.

FIG. 4 is a diagram illustrating a data flow between various supplier input display pages in one embodiment.

FIG. 5 is a diagram illustrating a display page for receiving a monthly resources status from a supplier in one embodiment.

FIG. 6 is a diagram illustrating a display page for receiving a monthly product delivery status from a supplier in one embodiment.

FIG. 7 is a diagram illustrating a display page for receiving a monthly invoice status from a supplier in one embodiment.

FIG. 8 is a diagram illustrating a display page for receiving a monthly purchase order status from a contracting company in one embodiment.

FIG. 9 is a diagram illustrating a display page for receiving a monthly special project status from a supplier in one embodiment.

FIG. 10 is a diagram illustrating a display page for presenting monthly human resources data in one embodiment.

FIG. 11 is a diagram illustrating a display page for presenting year-to-date human resources data in one embodiment.

FIG. 12 is a diagram illustrating a display page for presenting product delivery data in one embodiment.

FIG. 13 is a diagram illustrating a display page for presenting financial data in one embodiment.

FIG. 14 is a diagram illustrating a display page for presenting special projects data in one embodiment.

### DETAILED DESCRIPTION

Methods and systems are described for monitoring supplier performance. In one embodiment, a computer-based system allows a company that contracts with one or more suppliers in a global supplier base to obtain performance metrics for those suppliers on a regular basis, such as a monthly basis. These performance metrics can include utilization of manpower, timeliness of deliveries, submittal of invoices, quality of work, and other information regarding supplier performance. Use of these metrics allows the contracting company to quickly assess the cost-effectiveness of its supplier base.

In one embodiment, the method is implemented on a general-purpose computer, such as a personal computer, by a first supplier who accesses one or more user interface display pages from a web site. The first supplier enters various performance-related information onto these display pages. Such information can include manpower allocations, product deliveries, and outstanding invoices for the previous month. In general, suppliers will input data on a monthly basis. This information is then transmitted over a suitable communications link to a server computer where it is automatically stored in one or more databases. In a further aspect of this embodiment, a second supplier accesses one or more similar display pages from the web site and enters similar information for the previous month. This data entry process can be repeated for each of the suppliers in a contracting company's supplier base until all suppliers have entered their data. In one aspect of this embodiment, the system is protected such that each supplier will only have access to its own data. In contrast, the contracting company will be able to access data related to all the individual suppliers. After receiving the supplier input, the server computer automatically compiles the data into summary spreadsheets and other formats that illustrate the combined performance of the entire supplier base for the respective month.

In a further embodiment, the contracting company (contractor) operates a general-purpose computer to access one or more display pages from the web site that contain the compiled supplier performance data. As will be explained in greater detail below, this data can include a summary of supplier metrics for the entire supplier base, such as the overall head count for outside suppliers and the overall budget for outside suppliers. This data can also include information specific to individual suppliers, such as timeliness of supplier deliverables and quantity of work invoiced. The contractor can utilize this data to review the overall performance of the supplier base and to identify any deficiencies associated with individual suppliers. One advantage of the supplier performance monitoring system described herein is the relative ease with which a contractor can readily obtain information related to a global supplier base. A further advantage is a standardization of supplier metrics.

Certain embodiments and methods of the systems described for monitoring supplier performance are described in the context of computer-executable instructions performed by a general-purpose computer, such as a personal computer. In one embodiment, for example, these computer-executable instructions are stored on a computer-readable medium, such as a floppy disk or CD-ROM. In other embodiments, instructions are stored on a server computer system and accessed via a communications link or computer network such as an intranet or the Internet. Because the basic structures and functions related to computer-executable routines and corresponding computer implementation systems are well known, they have not been shown or described in detail here to avoid unnecessarily obscuring the described embodiments. Although the following disclosure provides specific details for a thorough understanding of several embodiments of the supplier performance monitoring system, one of ordinary skill in the relevant art will understand that these embodiments may be practiced without some of these details. In other instances, it will be appreciated that the methods and systems described can include additional details without departing from the spirit or scope of the disclosed embodiments.

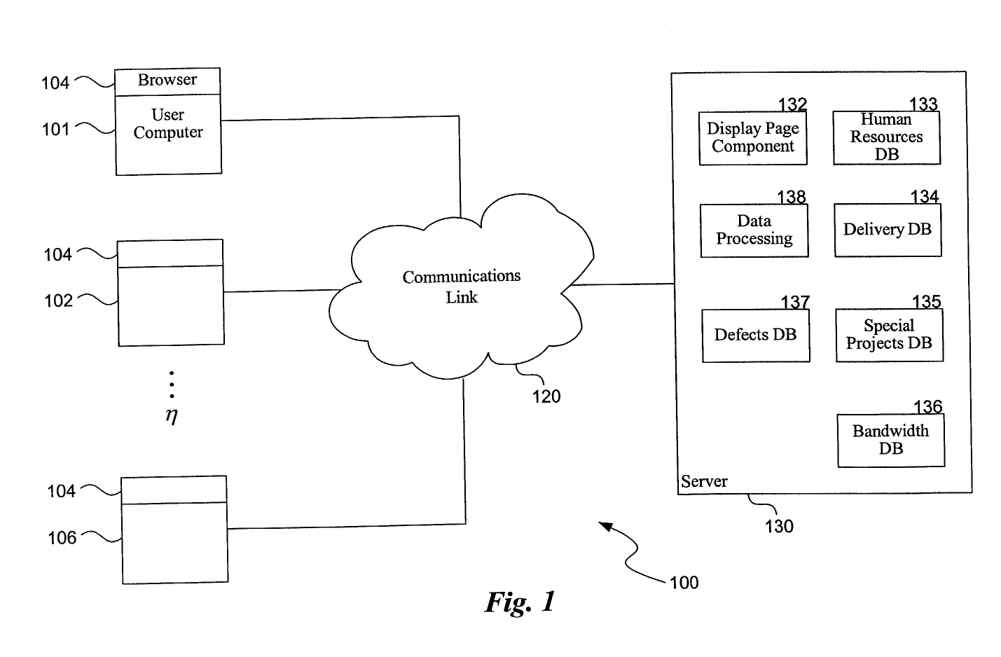

FIG. 1 is a block diagram illustrating components of a supplier performance monitoring system 100 in one embodiment. One or more supplier computers, such as a first supplier computer 101 and a second supplier computer 102, and a contractor computer 106, are connected to a server computer 130 via a communications link 120. In one aspect of this embodiment, the contractor computer 106 may be operated by a company that contracts with a global supplier base to monitor the performance of the respective suppliers. The one or more supplier computers 101 and 102 may likewise be operated by suppliers to input monthly performance data. In one aspect of this embodiment, the supplier and contractor computers 101, 102 and 106 are general-purpose computers, such as personal computers, and may include a central processing unit, memory devices, input devices (e.g., keyboard and pointing devices), output devices (e.g., display devices), and storage devices (e.g., disk drives). The memory and storage devices are computer-readable media that may contain computer instructions for implementing methods and systems, such as routines and display pages, in accordance with this disclosure. The supplier and contractor computers 101, 102 and 106 may also include a browser module 104 that allows a user to access and exchange data with the communications link 120, including web sites within the World Wide Web portion of the Internet. In a further aspect of this embodiment, the communications link 120 is a computer network, such as a local area network (LAN), an intranet or the Internet.

In one embodiment, the server computer 130 includes a number of facilities for performing aspects of the supplier performance monitoring system 100. For example, the server computer 130 includes a display page component 132 that contains user interface display pages for receiving supplier input in addition to summary report display pages for presenting supplier performance reports. The server computer 130 further includes a data processor 138 that processes and compiles the various data received from the respective suppliers and automatically generates corresponding performance reports.

The server computer 130 of the illustrated embodiment also includes a number of data stores, such as databases. For example, it includes a human resources database 133, a delivery database 134, a special projects database 135, a bandwidth database 136, and a defects database 137. The human resources database 133 stores information related to human resources utilization at the respective suppliers. The delivery database 134 stores information related to the quantity and timeliness of work product deliveries from the various suppliers to the contractor. The special projects database 135 stores information related to the nature and quantity of special projects undertaken by the various suppliers. The bandwidth database 136 stores information related to the computer infrastructure available at the respective suppliers. The defects database 137 stores information related to the percentage of defective products delivered by the various suppliers, in addition to information related to the time expended correcting the defects. As will be apparent to those of ordinary skill in the relevant art, the foregoing databases are only representative of those that may be included in the supplier performance monitoring system 100. Accordingly, in other embodiments, more, fewer, or other databases can be provided to suit the needs of a particular contractor in a particular industry.

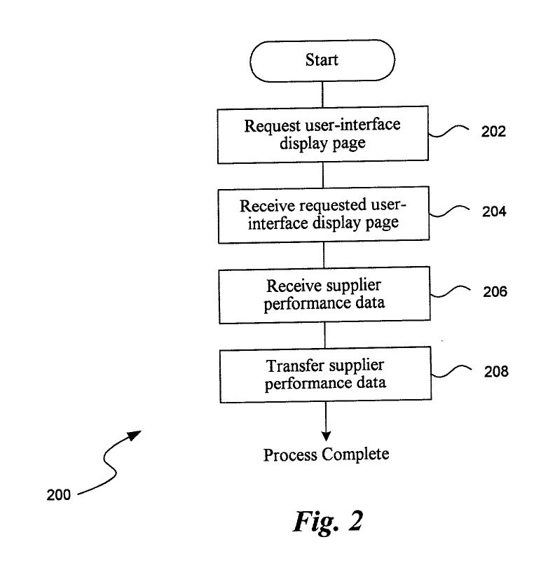

FIG. 2 is a flow diagram illustrating a process 200 for providing supplier performance data to a server computer in one embodiment. In one aspect of this embodiment, the process 200 may be implemented by a browser on one of the supplier computers 101 or 102 of FIG. 1. In block 202, the supplier computer requests a user interface display page from the server computer, for example, in response to an input or selection from a user, such as a supplier. In block 204, the supplier computer receives the requested user interface display page from the server computer. In this embodiment, the requested user interface display page is configured to receive various types of supplier performance data for a past time period, such as the previous month. For example, in one embodiment, the requested user interface display page can be configured to receive human resources data indicative of the number of individuals a supplier had working on a particular project or working for a particular contractor. In another embodiment, the requested user interface display page can be configured to receive product delivery data reflecting the number of products delivered to the contractor in the previous month and the timeliness of the product deliveries. In alternate embodiments, the requested user interface display page can be configured to receive other types of supplier data for other types of time periods. For example, in one such alternate embodiment, the requested user interface display page can be configured to receive performance data for a past year. In yet other embodiments, the user interface display page can be configured to receive estimates of expected performance data for a future time period. In block 206, the supplier computer receives the supplier performance data the requested user interface display page is configured to receive, for example, by way of input from a user, such as a supplier. In block 208, the supplier computer transfers the received supplier performance data to a server computer, such as the server computer 130 of FIG. 1, and the process 200 is complete.

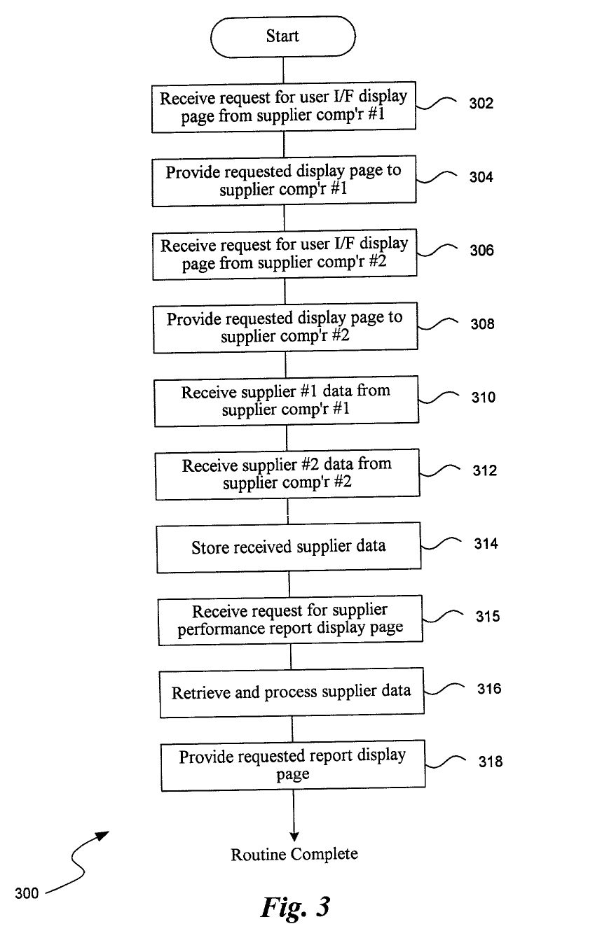

FIG. 3 is a flow diagram of a routine 300 for providing a supplier performance report to a user computer in one embodiment. In one aspect of this embodiment, the routine 300 can be implemented by the server computer 130 of FIG. 1 by receiving performance data from remote supplier computers 101 and 102 and providing a summary report to the contractor computer 106. In block 302, the routine receives a request for a user interface display page from the first supplier computer 101. In block 304, the routine provides the requested display page to the first supplier computer 101. In block 306, the routine receives a request for a user interface display page from the second supplier computer 102. In block 308, the routine provides the requested user interface display page to the second supplier computer 102. In one aspect of this embodiment, the requested user interface display pages provided to the first and second supplier computers 101 and 102 are configured to receive various types of supplier performance data for a past time period, such as the previous month.

In blocks 310 and 312, the routine receives supplier performance data from the first and second supplier computers 101 and 102, respectively. In block 314, the routine stores the received data in one or more databases, such as the databases 133-138 of FIG. 1. In block 315, the routine receives a request for the supplier performance data in, for example, a summary report display page format, from a user computer, such as the contractor computer 106 of FIG. 1.

In block 316, the routine retrieves the supplier data from the one or more databases and processes the data in response to the request received in block 315. In one aspect of this embodiment, the routine can process the received supplier performance data by retrieving it from one or more of the databases and combining the data received from the first supplier computer 101 with the data received from the second supplier computer 102. For example, assume that the routine receives human resources data from the first supplier computer 101 corresponding to the number of first supplier employees who worked on projects for the contractor the previous month. Also assume that the routine similarly receives human resources data from the second supplier computer 102 corresponding to the number of second supplier employees who worked on projects for the contractor the previous month. If, in this example, the first and second suppliers were the only suppliers working for the contractor that month, then the human resources data received from the first and second supplier computers 101 and 102 can be combined to determine a cumulative head count corresponding to the total number of supplier employees who worked for the contractor the previous month. In a similar example, invoice data received from both the first and second supplier computers 101 and 102 can be combined to determine a total value corresponding to the outstanding invoices for the previous month. In other embodiments, the received supplier performance data can be processed in other ways to provide other types of useful information to the contracting company.

In block 318, the routine provides the requested supplier performance report display page to the contractor computer 106 and the routine is complete. In one embodiment, the requested supplier performance report display page can be configured to provide various types of supplier performance data. As described above, for example, a supplier performance report in one embodiment can include supplier head counts or supplier product delivery data. These supplier performance reports can contain both individual supplier data or cumulative supplier data for the entire global supplier base.

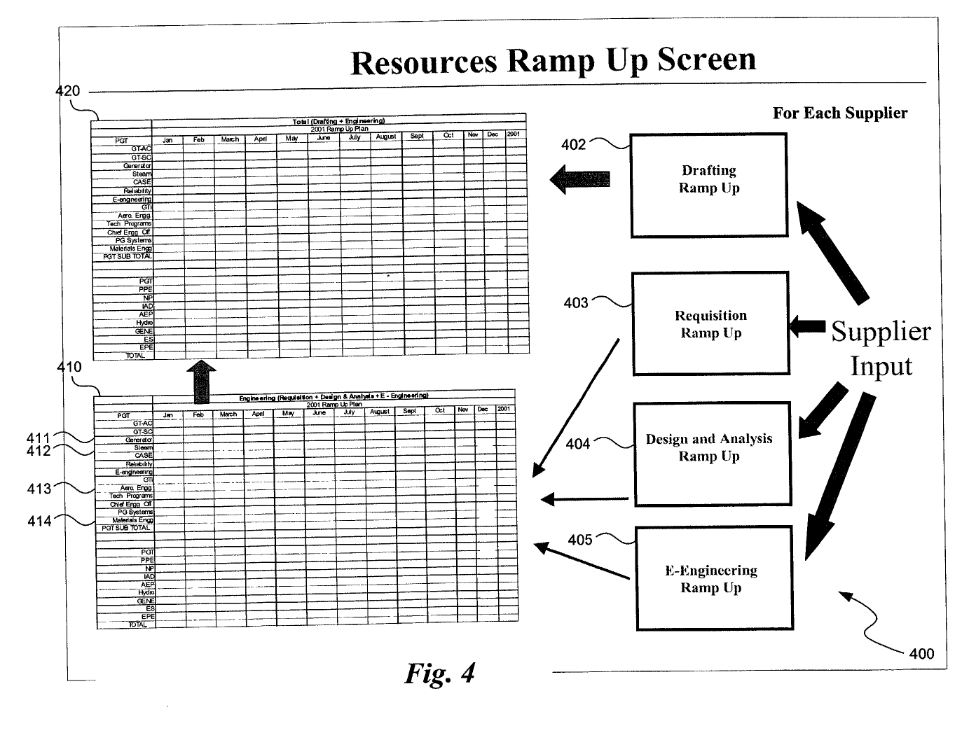

FIG. 4 is a diagram illustrating a data flow 400 between various supplier input display pages in one embodiment. In one aspect of this embodiment, the supplier inputs head count data for an upcoming year into the display pages 402-405. The supplier enters this data for each month of the year and for each of the different organizations within the contracting company for which the supplier expects to provide the respective products and services. This data is then rolled up into a projected engineering resources plan 410 and a projected total resources plan 420.

In one aspect of this embodiment, the display pages shown in FIG. 4 are configured to receive supplier human resources data. For example, a drafting display page 402 is configured to receive a month-by-month head count of the number of individuals performing drafting work for a particular contractor in a given year. A requisition display page 403 is configured to receive similar information for individuals engaged in requisitioning of engineering resources. A design and analysis display page 404 is configured to receive similar information for individuals engaged in design and analysis work. An E-engineering display page 405 is configured to receive similar information for individuals engaged in computer-related engineering, such as computer programming. In the illustrated embodiment, the terms “requisitioning,” “design and analysis,” and “E-engineering” all fall under the heading of “engineering” as distinct from “drafting.” In other embodiments, the supplier input display pages shown in FIG. 4 can be configured to receive other types of supplier performance data, such as product delivery data or invoice submittal data.

The arrows in FIG. 4 illustrate the flow of supplier data between the supplier input display pages 402-405 and the resources plans 410 and 420. In one aspect of this embodiment, the supplier will enter the respective data on the display pages 402-405 and then electronically transmit this data to the server computer 130 (FIG. 1) for storage in one or more databases. In response to a user request for a performance report display page, the server computer 130 can process this data and compile the engineering resources plan 410 and the total resources plan 420.

The engineering resources plan 410 is divided into 12 columns representing each of the 12 months. A plurality of rows are also provided corresponding to individual organizations within the contracting company. The engineering resources plan 410 can be divided in any way that is useful for the particular application. In the illustrated embodiment, for example, the organizations include a generator organization 411, a steam organization 412, an aero-engineering organization 413, and a materials engineering organization 414. This organizational breakdown is by no means exhaustive, and other breakdowns can be chosen to suit the particular application. Accordingly, after the supplier has input the relevant data into the requisition, design and analysis, and E-engineering display pages 403-405, the engineering resources plan 410 will populate with the engineering head count totals for each month and for each of the respective contractor organizations. The total resources plan 420 will similarly populate with a combined head count for the engineering and drafting tasks. Accordingly, the resources plans 410 and 420 can be viewed as supplier reports that illustrate planned allocation of human resources for a particular contractor and a particular year. If there are no changes to the engineering and drafting requirements throughout the year, then the resources plans 410 and 420 should not change over the year.

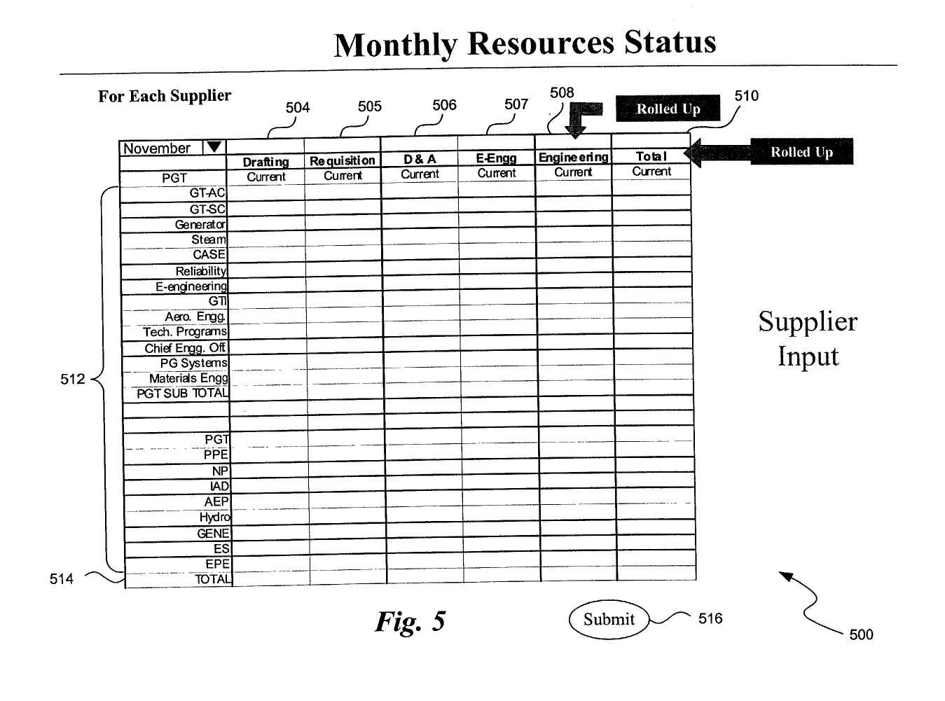

FIG. 5 is a diagram illustrating a display page 500 for receiving a monthly human resources status from a supplier in one embodiment. In one aspect of this embodiment, the display page 500 can be used by the supplier to input actual manpower usage for a previous month. The supplier enters the respective month in a month identifier field 502. In one embodiment, the month identifier field 502 includes a dropdown list that includes all 12 months from which the supplier can choose. In other embodiments, the supplier simply types the relevant month in the month identifier field 502.

In the illustrated embodiment, the display page 500 is arranged in spreadsheet format, and includes columns divided into different job descriptions across a top portion, and rows divided into different organizations, or functional groups, within the contracting company, along an organization portion 512. The display page 500 includes a drafting column 504, a requisition column 505, a design and analysis column 506, and an E-engineering column 507. The requisition, design and analysis, and E-engineering disciplines all fall under the general description of engineering tasks, and, accordingly, data entered in columns 505-507 is totaled in an adjacent engineering column 508. Similarly, the combined total from the drafting column 504 and the engineering column 508 can be presented in a total column 510.

The display page 500 also includes one or more organization identifiers in the organization portion 512. In one aspect of this embodiment, each row in the display page 500 is dedicated to a separate organization within the contracting company. As seen in FIG. 5, these organizations can include reliability, E-engineering, aero-engineering, and materials engineering. Although these organizations are identified according to technical discipline, in other embodiments, these organizations can be identified using other criteria. For example, in one embodiment, each row in FIG. 5 can correspond to a different division of the contracting company. In another embodiment, the organizations identified in FIG. 5 can be limited to only those for which the particular supplier provides services. In yet other embodiments, other criteria can be used for grouping manpower requirements.

In one embodiment, the supplier accesses the display page 500 each month and enters actual manpower usage for the previous month into the respective fields. As the supplier enters the data, the manpower totals are displayed in a total row 514. After the supplier has input all the manpower usage for the previous month, the supplier transfers this data to the server computer 130 (FIG. 1) by selecting a submit button 516. As will be apparent to those of ordinary skill in the relevant art based on the foregoing discussion of FIGS. 4 and 5, the display pages 410 and 420 of FIG. 4 can be generally described as “planned” or “expected” manpower usage reports, and the display page 500 of FIG. 5 can be generally described as an “actual” manpower usage report.

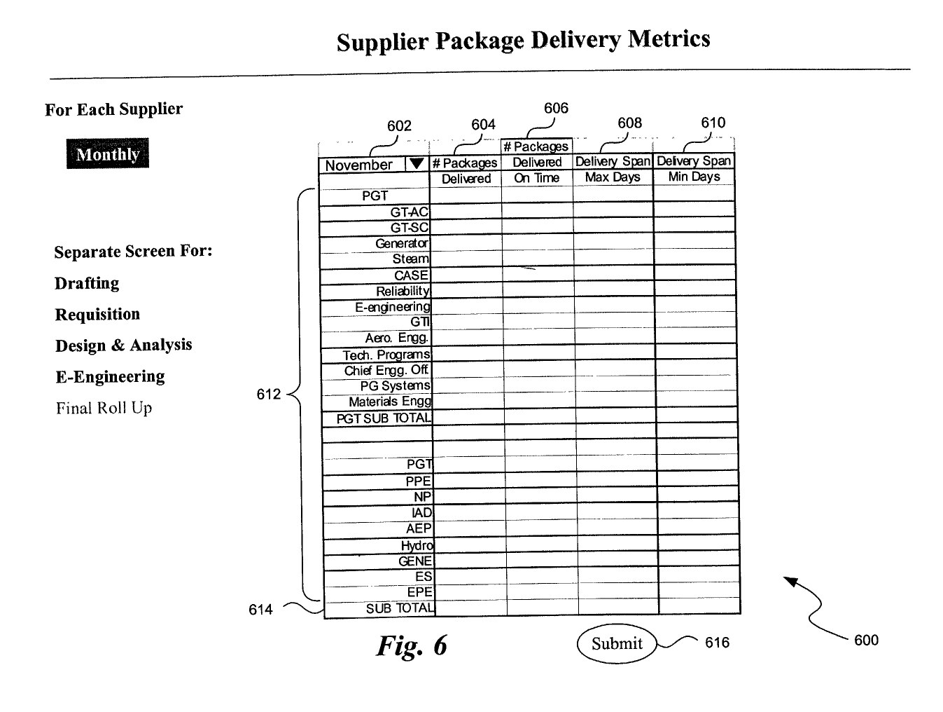

FIG. 6 is a diagram illustrating a display page 600 for receiving a monthly product delivery status from a supplier in one embodiment. In one aspect of this embodiment, the display page 600 can be used by the supplier to input actual product delivery data for a previous month. The display page 600 includes a delivered column 604, a delivered on-time column 606, a max delivery span column 608, and a min delivery span column 610. Like the display page 500 of FIG. 5, the display page 600 also includes an organization portion 612 listing different organizations within the contracting company, and a month identifier field 602 configured to receive the respective month.

In one aspect of this embodiment, the supplier inputs the number of product packages delivered to a respective organization in the delivered column 604. The supplier enters the number of the delivered packages that were delivered on time in the delivered on time column 606. The supplier enters the maximum number of days late a package was delivered in the max delivery span column 608, and the maximum number of days early a package was delivered in the min delivery span column 610. As the supplier enters the data in the respective fields in the display page 600 for each of the different organizations, the data is totaled in a total row 614. After the supplier has input all the package delivery information for the previous month, the supplier can transmit this data to the server computer 130 (FIG. 1) by selecting a submit button 616.

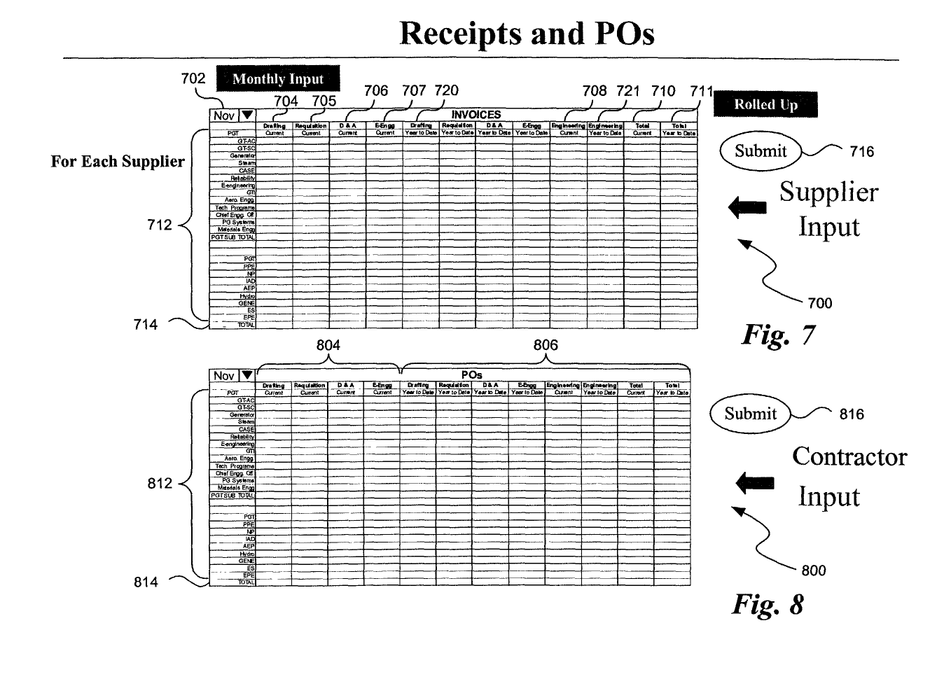

FIG. 7 is a diagram illustrating a display page 700 for receiving a monthly invoice status from a supplier in one embodiment. In one aspect of this embodiment, the display page 700 can be used by the supplier to input the actual dollar values of invoices submitted to the contracting company for the previous month. The user can identify the corresponding month in a month identifier field 702. The display page 700 includes a drafting invoices column 704, a requisition invoices column 705, a design and analysis invoices column 706, and an E-engineering invoices column 707. Requisition, design and analysis, and E-engineering invoices fall under the general heading of “engineering” invoices. Accordingly, after the supplier has entered the respective data in the columns 705-707, the cumulative engineering invoices are automatically displayed in a current engineering invoice column 708.

The display page 700 further includes one or more columns that display year-to-date totals for the different types of invoices. For example, the display page 700 includes a year-to-date drafting column 720 and a corresponding year-to-date engineering column 721. These year-to-date columns are, accordingly, automatically updated after the supplier has entered the monthly data in the adjacent current invoice columns. A total current invoice column 710 and a total year-to-date invoice column 711 display the total current invoices and the total year-to-date invoices, respectively, for the different organizations listed in an organization portion 712. After the supplier has populated the respective invoice fields for the current month's invoice activity, totals are presented in a total row 714. After the supplier is satisfied that the display page 700 has been sufficiently updated with the previous month's invoice data, the supplier can transmit this data to the server computer 130 (FIG. 1) by selecting a submit button 716.

FIG. 8 is a diagram illustrating a display page 800 for receiving a monthly purchase order status from a contracting company in one embodiment. In one aspect of this embodiment, the display page 800 can be used by the contracting company (i.e., the contractor) to input actual purchase orders placed with a particular supplier for a previous month. The purchase order display page 800 is similar in both structure and function to the invoice status display page 700 of FIG. 7. For example, the contractor enters actual dollar values of purchase orders placed with the supplier during the previous month in a current purchase order portion 804. Year-to-date totals for placed purchase orders are then displayed in the adjacent year-to-date purchase order portion 806. As with many of the previous display pages described above, the purchase order data is separated into different groups according to the organization portion 812. After the contractor has input the purchase order data, totals for each type of purchase order are displayed in a total row 814. The contractor can transmit this purchase order data to the server computer 130 (FIG. 1) by selecting a submit button 816.

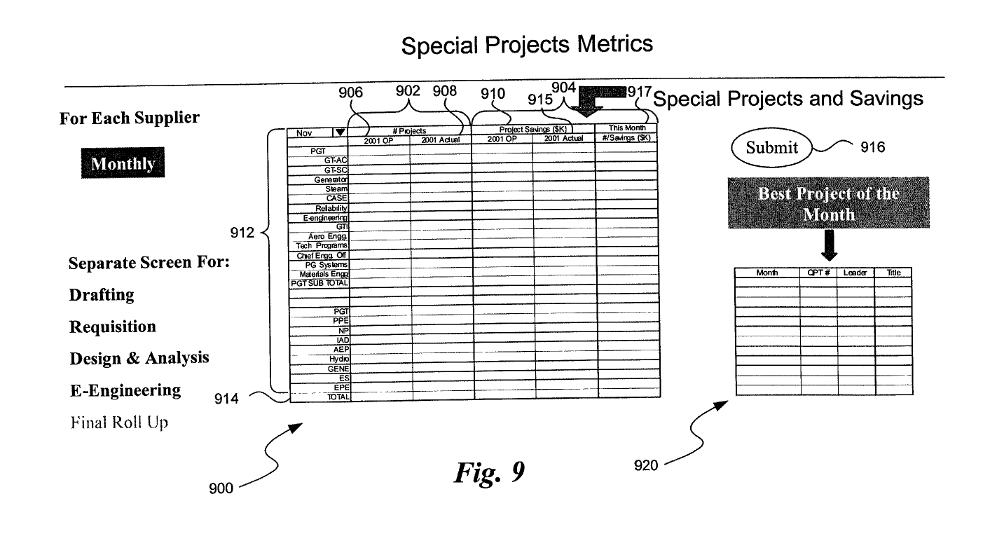

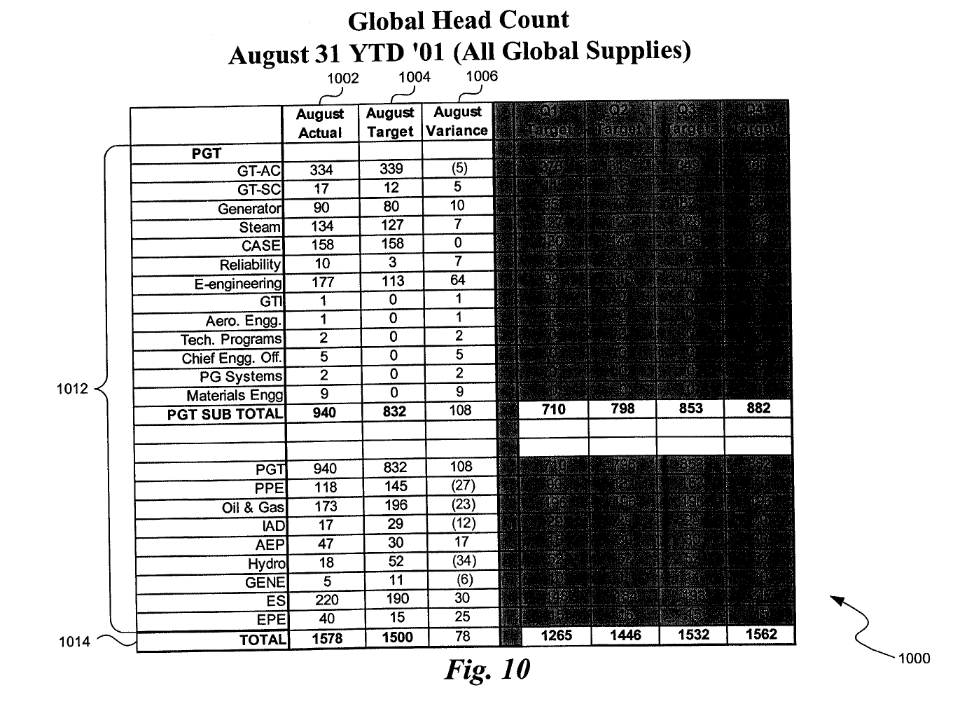

FIG. 9 is a diagram illustrating a display page 900 for receiving a monthly special project status from a supplier in one embodiment. In one aspect of this embodiment, the display page 900 can be used by the supplier to enter actual project data for a previous month. Such special projects may include quality enhancement projects, such as Six Sigma quality enhancement projects. In other embodiments, other types of cost savings initiatives and projects can be tracked using the display page 900.

The display page 900 includes a project number portion 902 and a project savings portion 904. The numbers of planned special projects are displayed in a planned projects column 906. The projected savings for all the planned projects are displayed in a planned savings column 910. In one aspect of this embodiment, the numbers of planned projects and the corresponding projected savings are pre-entered at the beginning of a year and do not change throughout the year. The supplier enters the actual number of special projects completed to date in an actual projects column 908. The supplier enters the actual savings from all the special projects completed to date in an actual savings column 915. The actual savings realized in the previous month from special projects are displayed in a per-month savings column 917.

As with many of the display pages described above, the special project data is divided according to which organization within the contracting company the project is related to. These organizations are listed in an organization portion 912. Totals for the various types of project data across all the different organizations are displayed in a total row 914. After the supplier has sufficiently updated the display page 900, the supplier can transmit the corresponding data to the server computer 130 (FIG. 1) by selecting the submit button 916. In a further aspect of this embodiment, a separate display page similar to the display page 900 can be updated by the supplier on a generally regular basis, such as a monthly basis, for each type of special project. For example, this can be done for drafting, requisition, design and analysis, and E-engineering special projects.

Many of the display pages described above in accordance with FIGS. 4-9 are configured to receive monthly supplier performance data from suppliers in a global supplier base. After this data is received by the server computer 130 (FIG. 1), this data can be processed and arranged in a number of different ways to provide useful supplier performance information to the contracting company. In one embodiment, this information can include a number of display pages in a summary report format that allow the contractor to ascertain supplier performance at a glance. A number of these contractor report display pages are described below for purposes of illustration. Those of ordinary skill in a relevant art will appreciate, however, that various other contractor report display pages can be provided consistent with the present disclosure.

FIG. 10 is a diagram illustrating a display page 1000 for presenting monthly human resources data in one embodiment. In one aspect of this embodiment, the display page 1000 provides an actual head count for a given month of all supplier personnel working for the different organizations of a contracting company as listed in an organization portion 1012. In a further aspect of this embodiment, the data presented in the display page 1000 can be compiled from supplier data received by the server computer 130 from supplier computers, such as the supplier computers 101 and 102 (see FIG. 1).

The display page 1000 includes an actual head count column 1002, a target head count column 1004, and a variance column 1006. The actual head count column 1002 presents the combined head count for all the suppliers in the global supplier base for a given time period, such as the previous month. The adjacent target head count column 1004 presents the expected head count for that month, and the difference between the actual head count and the expected head count is presented in the variance column 1006. The total actual, total target, and total variance head counts for all the organizations are displayed in a total row 1014. Thus, the display page 1000 enables a contractor to quickly ascertain both the actual number of supplier personnel engaged in the previous month and the variance between the actual number and the target number.

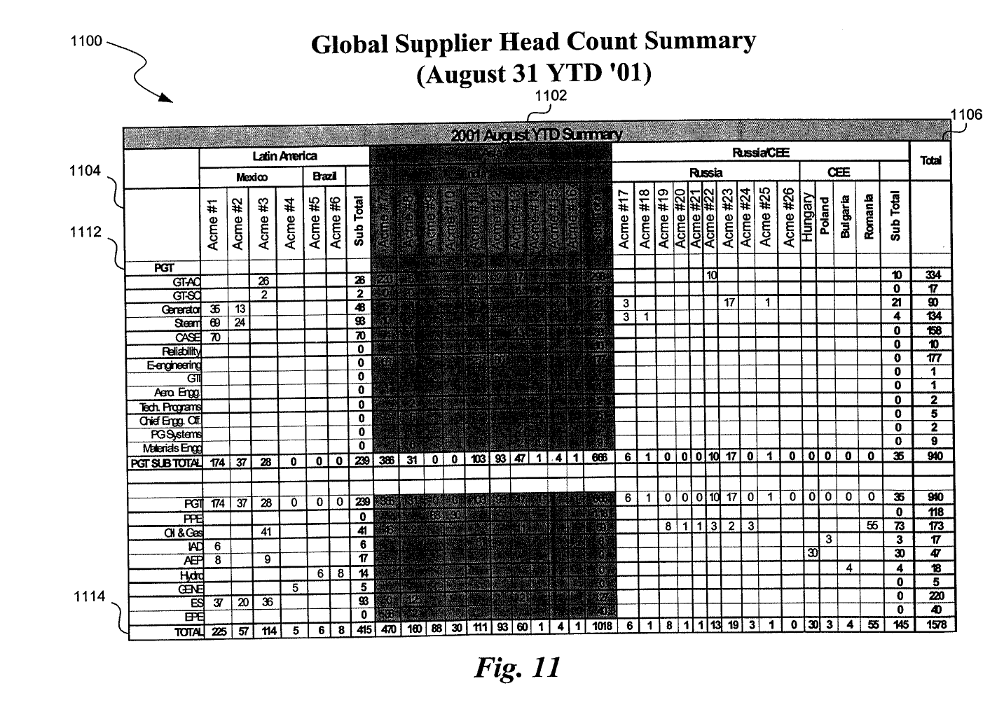

FIG. 11 is a diagram illustrating a display page 1100 for presenting year-to-date human resources data in one embodiment. In one aspect of this embodiment, the display page 1100 presents a global supplier head count for the year to date based on the geographical locations of the respective suppliers. In a further aspect of this embodiment, the data presented in the display page 1100 can be compiled from supplier data received by the server computer 130 from supplier computers, such as the supplier computers 101 and 102 (see FIG. 1).

In the illustrated embodiment, the supplier geographical regions are divided into Latin America, Asia and Russia/CEE. The suppliers located in each of these regions are listed in a supplier row 1104. The display page 1100 further includes a month identifier 1102 and an organization portion 1112. A total column 1114 displays the total number of supplier personnel who have worked for the different organizations for the year to date. A total row 1114 displays the total number of supplier personnel for each of the different suppliers who have worked for the contractor for the year to date. Accordingly, the display page 1100 enables a contractor to quickly ascertain both an organizational breakdown and a regional breakdown of supplier utilization for the year to date.

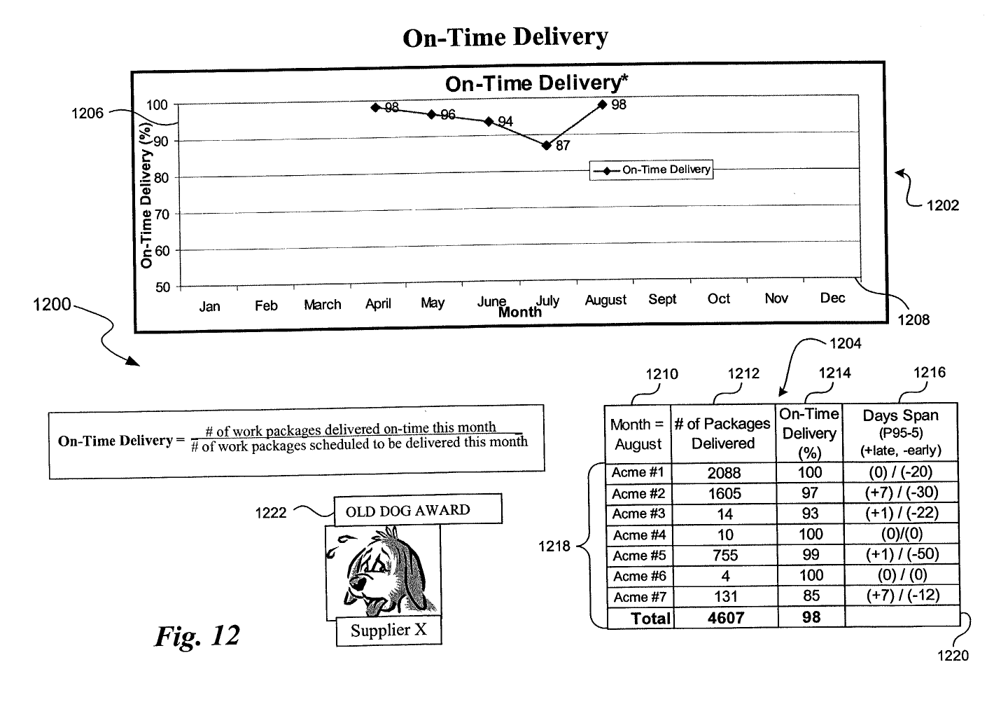

FIG. 12 is a diagram illustrating a display page 1200 for presenting product delivery data in one embodiment. In one aspect of this embodiment, the display page 1200 presents on-time product delivery statistics, such as for delivery of engineering or drafting work products, for all the suppliers in the global supplier base. In other embodiments, the display page 1200 can provide other types of product delivery data for individual suppliers or for other subsets of the supplier base. In a further aspect of this embodiment, the data presented in the display page 1200 can be compiled from supplier data received by the server computer 130 from supplier computers, such as the supplier computers 101 and 102 and the contractor computer 106 (see FIG. 1).

The display page 1200 includes an on-time delivery chart 1202 and an on-time delivery table 1204. The on-time delivery chart 1202 measures on-time delivery percentages along a vertical axis 1206 and indicates respective months on a horizontal axis 1208. In the illustrated embodiment, the percentage of on-time deliveries for a given month is equivalent to the number of products delivered on time in that month divided by the total number of products delivered in that month multiplied by 100.

The on time delivery table 1204 includes a month identifier 1210, a delivered packages column 1212, an on-time delivery column 1214, and a delivery span column 1216. The on-time delivery table also includes a supplier column 1218 that accordingly identifies the respective suppliers. The data presented in the delivered packages column 1212 are the number of packages delivered year to date by the respective suppliers. The percentages of those packages that were delivered on time are presented in the on-time delivery column 1214. The maximum and minimum delivery time span for each of the suppliers is presented in the delivery span column 1216. In the parentheses, “+late” indicates the latest package delivery, and “−early” indicates the earliest package delivery. A total row 1220 presents the total number of packages delivered to date and the corresponding percentage of those packages that were delivered on time. In the spirit of continuous improvement, the supplier with the worst product delivery record can be given a suitable “award,” such as an old dog award 1222, as recognition of its poor performance and need for improvement.

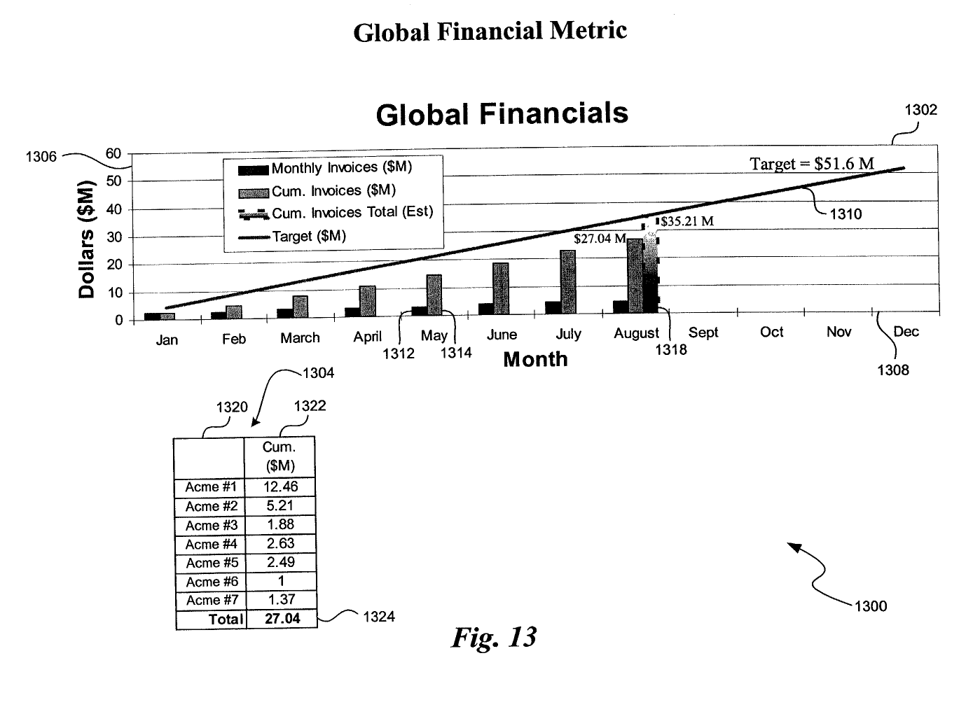

FIG. 13 is a diagram illustrating a display page 1300 for presenting financial data in one embodiment. In one aspect of this embodiment, the display page 1300 presents an invoice status for all the suppliers in the global supplier base. In other embodiments, the display page 1300 can provide other types of invoice data for individual suppliers or for other subsets of the supplier base. In a further aspect of this embodiment, the data presented in the display page 1300 can be compiled from supplier data received by the server computer 130 from supplier computers, such as the supplier computers 101 and 102 and the contractor computer 106 (see FIG. 1).

The display page 1300 includes a financial data chart 1302 and a financial data table 1304. The financial data chart 1302 measures invoices in millions of dollars along a vertical axis 1306 and indicates respective months along a horizontal axis 1308. The target line 1310 on the financial data chart 1302 represents the expected cumulative value of invoices received from the global supplier base based on the purchase orders placed with the global supplier base. The first bar 1312 for each of the illustrated months represents the invoices received from the global supplier base for that month. The second bar 1314 represents the year-to-date cumulative invoices received up to the respective month. A third bar 1318 represents the expected cumulative invoice value based on the target line 1310. Thus, the financial data chart 1302 enables a contractor to ascertain the progress of supplier work relative to the value of invoices received.

The financial data table 1304 includes a supplier column 1320 and a cumulative invoice column 1322. Each of the suppliers is listed in the supplier column 1320, and the cumulative invoices for the respective suppliers are presented in the adjacent cumulative invoice column 1322. The total cumulative value of the invoices received from all the suppliers in the global supplier base is provided in the total field 1324.

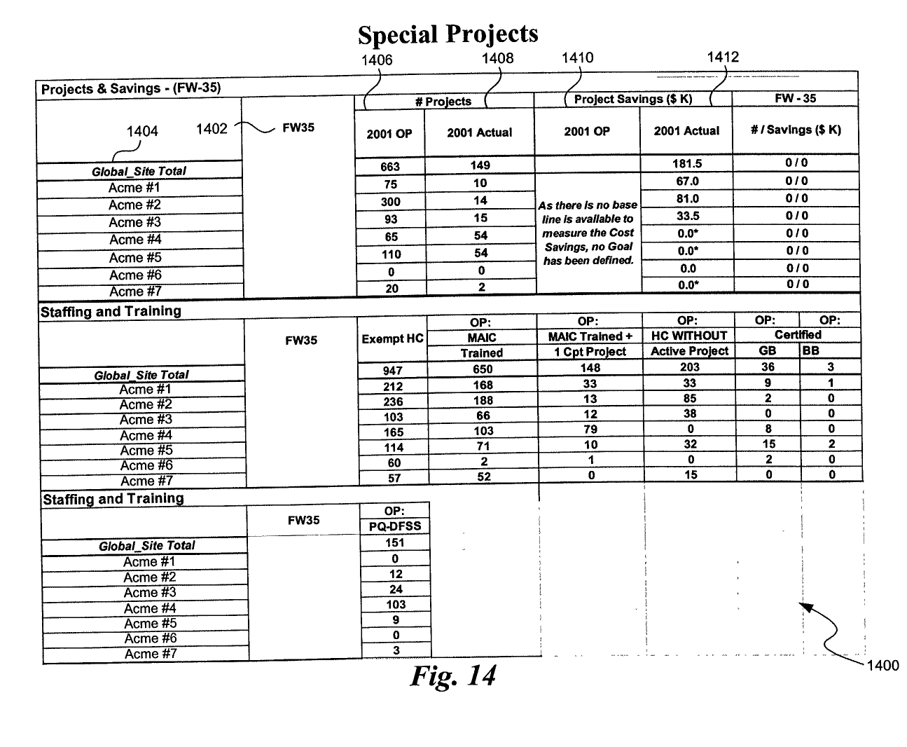

FIG. 14 is a diagram illustrating a display page 1400 for presenting special projects data in one embodiment. In one aspect of this embodiment, the display page 1400 can provide cost savings data associated with special projects, such as quality enhancement projects, undertaken by the suppliers in a global supplier base. In a further aspect of this embodiment, the data presented in the display page 1400 is compiled from special projects data received by the server computer 130 from supplier computers, such as the supplier computers 101 and 102 and the contractor computer 106 (see FIG. 1).

The display page 1400 includes a fiscal week identifier 1402, a supplier column 1404, a planned projects column 1406, and an actual projects column 1408. The number of special projects planned for each supplier are shown in the planned projects column 1406, and the actual number of special projects undertaken by each supplier are shown in the adjacent actual projects column 1408. The display page 1400 further includes a number of aspects for presenting cost savings data related to the special projects, such as a projected savings column 1410, an actual savings column 1412, and a per-week savings column 1414. The actual savings column 1412 presents the cumulative savings associated with special projects for each of the suppliers, while the per-week savings column 1414 presents the total savings for the respective fiscal week as shown by the fiscal week identifier 1402.

Although the foregoing display pages described above in accordance with FIGS. 4-14 illustrate selected embodiments of supplier performance summary reports, those of ordinary skill in a relevant art will appreciate that numerous other embodiments are possible consistent with the present disclosure. Accordingly, the foregoing display pages are only representative of those contemplated, and should not be considered exhaustive. For example, in alternate embodiments, display pages can be provided for receiving and presenting supplier data related to the number of defects found in supplier-provided work product. Similarly, display pages can also be provided for receiving and presenting supplier data related to the amount of time expended repairing or otherwise responding to supplier defects. In a further embodiment, display pages could be provided for receiving or presenting supplier data related to computer bandwidth available at each supplier. In this embodiment, the kilobytes-per-second available for data transmissions to and from the different suppliers would be documented, and the response time for such data transmissions would be monitored. A corresponding bandwidth summary report could be provided to the contracting company on a monthly or yearly basis to provide a status of supplier bandwidth performance.

It will be appreciated from the foregoing that although specific embodiments of the supplier performance monitoring system have been described for purposes of illustration, various modifications may be made without deviating from the spirit or scope of the invention. Further, although the methods and systems have been described in the context of suppliers of engineering or drafting services, it will be understood by those of ordinary skill in the relevant art that the methods and systems disclosed here are equally well suited for other types of suppliers. Those of ordinary skill in the relevant art will also appreciate that these and other changes can be made to the invention in light of the above detailed description.

While certain aspects of the invention are presented below in certain claim forms, the inventors nevertheless contemplate various embodiments of the invention consistent with other claim forms. Accordingly, the inventors reserve the right to add additional claims after filing the application to pursue such additional claim forms for all aspects of the invention as contemplated. Further, the terms used in the following claims should not be construed to limit the invention to the specific embodiments disclosed in the specification or claims, but instead should be construed to include all supplier monitoring systems that operate in accordance with the claims. The scope of the invention is therefore not limited by this disclosure, but, instead, the scope of the invention is to be determined entirely by the following claims.

We claim:

1. A method in a computer system for providing information related to at least a first and second supplier, the first and second suppliers providing services for a contracting company, the method comprising:
receiving a first request for a first user interface display page from the first supplier;
in response to the received first request, providing the requested first user interface display page to the first supplier, the requested first user interface display page being configured to receive first supplier information, the first supplier information related to the services provided by the first supplier for the contracting company;
receiving the first supplier information from the first supplier;
receiving a second request for a second user interface display page from the second supplier;
in response to the received second request, providing the requested second user interface display page to the second supplier, the requested second user interface display page being configured to receive second supplier information, the second supplier information related to the services provided by the second supplier for the contracting company;
receiving the second supplier information from the second supplier;
compiling the first and second supplier information;
receiving a third request from the contracting company for a supplier report display page; and
in response to the received third request, providing the requested supplier report display page to the contracting company, the requested supplier report display page containing at least a portion of the compiled first and second supplier information.

2. The method of claim 1 wherein the first and second user interface display pages are configured to receive manpower data, work product delivery data, invoice data, or work product defect data.

3. The method of claim 1 wherein:
the first and second user interface display pages are configured to receive head count data related to supplier personnel who provided services for the contracting company; and
the supplier report display page contains at least a portion of the received head count data.

4. The method of claim 1 wherein:
the first and second user interface display pages are configured to receive delivery data related to work product delivered to the contracting company; and
the requested supplier report display page contains at least a portion of the received delivery data.

5. The method of claim 1 wherein:
the first and second user interface display pages are configured to receive invoice data related to invoices submitted to the contracting company; and
the requested supplier report display page contains at least a portion of the received invoice data.

6. The method of claim 1 wherein:
the first and second user interface display pages are configured to receive project data related to quality enhancement projects undertaken; and
the requested supplier report display page contains at least a portion of the received project data.

7. The method of claim 1 wherein:
the first and second user interface display pages are configured to receive defect data related to defective work product provided to the contracting company; and
the requested supplier report display page contains at least a portion of the received defect data.

8. The method of claim 1 wherein:
the first and second user interface display pages are configured to receive supplier information separated according to an organizational structure of the contracting company; and
the requested supplier report display page contains at least a portion of the received supplier information separated according to the organizational structure.

9. A method in a computer system for providing information related to supplier performance, the method comprising:
receiving a request for a user interface display page from a first user computer;
in response to the received request, providing the requested user interface display page to the first user computer, the requested user interface display page being configured to receive supplier performance information;
receiving the supplier performance information from the user computer;
receiving a request for a supplier report display page from a second user computer; and
in response to the received request, providing the requested supplier report display page to the second user computer, the requested supplier report display page containing at least a portion of the received supplier performance information.

10. The method of claim 9 wherein the user interface display page is a first user interface display page configured to receive first supplier performance information, and further comprising:
receiving a request for a second user interface display page from a third user computer;
in response to the received request, providing the requested second user interface display page to the third user computer, the requested second user interface display page being configured to receive second supplier performance information;
receiving the second supplier performance information from the third user computer; and
processing the first and second supplier performance information, wherein the provided supplier report display page contains at least a portion of the processed first and second supplier performance information.

11. The method of claim 10 wherein processing the first and second supplier performance information includes combining the first supplier performance information with the second supplier performance information.

12. The method of claim 9 wherein:
the requested user interface display page is configured to receive head count data related to supplier personnel providing services in connection with a contractor; and
the requested supplier report display page contains at least a portion of the head count data.

13. The method of claim 9 wherein:
the requested user interface display page is configured to receive delivery data related to work product provided in connection with a contractor; and
the requested supplier report display page contains at least a portion of the delivery data.

14. The method of claim 9 wherein:
the requested user interface display page is configured to receive invoice data related to invoices submitted in connection with a contractor; and
the requested supplier report display page contains at least a portion of the invoice data.

15. The method of claim 9 wherein:
the requested user interface display page is configured to receive project data related to quality enhancement projects undertaken in connection with a contractor; and
the requested supplier report display page contains at least a portion of the project data.

16. The method of claim 9 wherein:
the requested user interface display page is configured to receive defect data related to defective work product provided in connection with a contractor; and
the requested supplier report display page contains at least a portion of the defect data.

17. The method of claim 9 wherein:
the requested user interface display page is configured to receive supplier performance information separated according to an organizational structure of a contracting company; and
the requested supplier report display page contains at least a portion of the supplier performance information separated according to the organizational structure.

18. A method in a computer system for providing information related to supplier performance to a server computer, the method comprising:
requesting a user interface display page from the server computer;
in response to the request, receiving the requested user interface display page from the server computer, the requested user interface display page being configured to receive selected supplier performance information;
receiving the selected supplier performance information; and
transmitting the received supplier performance information to the user computer.

19. The method of claim 18 wherein the requested user interface display page is configured to receive head count data related to supplier personnel providing services in connection with a contractor.

20. The method of claim 18 wherein the requested user interface display page is configured to receive delivery data related to work product provided in connection with a contractor.

21. The method of claim 18 wherein the requested user interface display page is configured to receive invoice data related to invoices submitted in connection with a contractor.

22. The method of claim 18 wherein the requested user interface display page is configured to receive project data related to quality enhancement projects undertaken in connection with a contractor.

23. The method of claim 18 wherein the requested user interface display page is configured to receive defect data related to defective work product provided in connection with a contractor.

24. The method of claim 18 wherein the requested user interface display page is configured to receive supplier performance information separated according to an organizational structure of a contracting company.

25. A computer system for providing information related to supplier performance, the computer system comprising:
means for receiving a request for a user interface display page from a first user computer;
means for providing the requested user interface display page to the first user computer in response to the received request, the requested user interface display page being configured to receive selected supplier performance information;
means for receiving the selected supplier performance information from the first user computer;
means for receiving a request for a supplier report display page from a second user computer; and
means for providing the requested supplier report display page to the second user computer in response to the received request, the requested supplier report display page containing at least a portion of the received supplier performance information.

26. The computer system of claim 25 wherein the user interface display page is a first user interface display page configured to receive first selected supplier information, and further comprising:
means for receiving a request for a second user interface display page from a third user computer;
means for providing the requested second user interface display page to the third user computer in response to the received request, the requested second user interface display page being configured to receive second selected supplier performance information;
means for receiving the second selected supplier performance information from the third user computer; and
means for processing the first and second supplier performance information, wherein the provided supplier report display page contains at least a portion of the processed first and second supplier performance information.

27. The computer system of claim 25 wherein:
the requested user interface display page is configured to receive head count data related to supplier personnel providing services in connection with a contractor; and
the requested supplier report display page contains at least a portion of the head count data.

28. The computer system of claim 25 wherein:
the requested user interface display page is configured to receive delivery data related to work product provided in connection with a contractor; and
the requested supplier report display page contains at least a portion of the delivery data.

29. The computer system of claim 25 wherein:
the requested user interface display page is configured to receive invoice data related to invoices submitted in connection with a contractor; and
the requested supplier report display page contains at least a portion of the invoice data.

30. The computer system of claim 25 wherein:
the requested user interface display page is configured to receive supplier performance information separated according to an organizational structure of a contracting company; and
the requested supplier report display page contains at least a portion of the supplier performance information separated according to the organizational structure.

31. A computer-readable medium whose contents cause a computer system to provide information related to services provided by a supplier for a contracting company, the information being provided by a method comprising:
receiving a request for a user interface display page from the supplier;
in response to the received request, providing the requested user interface display page to the supplier, the requested first user interface display page being configured to receive information related to the services provided by the supplier for the contracting company;
receiving, from the supplier, the information related to the services provided by the supplier;
receiving a request from the contracting company for a supplier report display page; and
in response to the received request, providing the requested supplier report display page to the contracting company, the requested supplier report display page containing at least a portion of the information received from the supplier.

32. The computer-readable medium of claim 31 wherein the supplier is a first supplier and the request for the user interface display page is a first request for a first user interface display page, the method further comprising:
receiving a second request for a second user interface display page from a second supplier;
in response to the received second request, providing the requested second user interface display page to the second supplier, the requested second user interface display page being configured to receive information related to services provided by the second supplier for the contracting company;
receiving, from the second supplier, the information related to the services provided by the second supplier; and
processing the information received from the first and second suppliers related to the services provided by the first and second suppliers, wherein the provided supplier report display page contains at least a portion of the processed information.

33. The computer-readable medium of claim 31 wherein the user interface display page is configured to receive manpower data, product delivery data, invoice data, or product defect data.

34. The computer-readable medium of claim 31 wherein:
the user interface display page is configured to receive head count data related to supplier personnel who provided services for the contracting company; and
the supplier report display page contains at least a portion of the head count data.

35. The computer-readable medium of claim 31 wherein:
the user interface display page is configured to receive delivery data related to work product delivered to the contracting company; and
the requested supplier report display page contains at least a portion of the delivery data.

36. The computer-readable medium of claim 31 wherein:
the user interface display page is configured to receive invoice data related to invoices submitted to the contracting company; and
the requested supplier report display page contains at least a portion of the invoice data.

37. The computer-readable medium of claim 31 wherein:
the user interface display page is configured to receive project data related to quality enhancement projects undertaken; and
the requested supplier report display page contains at least a portion of the project data.

38. The computer-readable medium of claim 31 wherein:
the user interface display page is configured to receive defect data related to defective work product provided to the contracting company; and
the requested supplier report display page contains at least a portion of the defect data.

39. The computer-readable medium of claim 31 wherein:
the user interface display page is configured to receive supplier information separated according to an organizational structure of the contracting company; and
the requested supplier report display page contains at least a portion of the supplier information separated according to the organizational structure.

40. A computer-readable medium containing a display page for receiving information related to services provided by a supplier for a contracting company, the display page comprising:
a time period field configured to receive an indication of a time period to which the supplier information relates;
a services description portion identifying at least one service provided by the supplier for the contracting company;
an organization portion identifying at least one organization within the contracting company for which the supplier has provided the at least one service; and
a performance metric field, the performance metric field configured to receive a metric related to the at least one service and the at least one organization.

41. The computer-readable medium of claim 40 wherein the display page is configured to receive supplier manpower information and the performance metric field is configured to receive a head count.

42. The computer-readable medium of claim 40 wherein the display page is configured to receive supplier invoice information and the performance metric field is configured to receive a dollar value.

43. The computer-readable medium of claim 40 wherein the display page is configured to receive work product delivery information and the performance metric field is configured to receive a count of work product deliveries.

44. The computer-readable medium of claim 40 wherein the time period field is configured to receive a selected month.

45. The computer-readable medium of claim 40 wherein the services description portion identifies an engineering service and a drafting service, the performance metric field is a first performance metric field configured to receive a first metric related to the engineering service, and wherein the display page further comprises:
a second performance metric field configured to receive a second metric related to the drafting service; and
a total metric field configured to present a third metric based on the first and second metrics.

46. The computer-readable medium of claim 40 wherein the services description portion identifies an engineering service and a drafting service, the performance metric field is a first performance metric field configured to receive a first head count related to the engineering service, and wherein the display page further comprises:
a second performance metric field configured to receive a second head count related to the drafting service; and
a total metric field configured to present a third head count based on the first and second head counts.

47. A computer-readable medium containing a display page for receiving information related to work product packages delivered to a contracting company, the display page comprising:
a time period field configured to receive an indication of a time period to which the information relates;
an organization portion identifying at least one organization within the contracting company to which the work product packages relate;
a packages delivered field configured to receive a count related to the work product packages; and
a packages delivered on time field configured to receive a count related to a portion of the work product packages delivered on time.

48. The computer-readable medium of claim 46 wherein the time period field is configured to receive a month.

49. The computer-readable medium of claim 46 further comprising a services description portion identifying at least one service to which the work product packages relate.

50. A computer-readable medium containing a display page for presenting information related to services provided by at least one supplier for a contracting company, the display page comprising:
a time period field configured to indicate a period of time to which the information relates;
a services description portion identifying at least one service provided by the at least one supplier for the contracting company;
an organization portion identifying at least one organization within the contracting company for which the at least one service was provided; and
a performance metric field, the performance metric field configured to present a metric related to the at least one service and the at least one organization.

51. The computer-readable medium of claim 50 wherein the display page presents information related to services provided by a first supplier and a second supplier for the contracting company, wherein the performance metric field is configured to present a metric related to a first service provided by the first supplier for the at least one organization and a second service provided by the second supplier for the at least one organization.

52. The computer-readable medium of claim 50 wherein the display page presents information related to services provided by a first supplier and a second supplier for the contracting company, wherein the performance metric field is a first performance metric field, and wherein the display page further comprises:
a second performance metric field; and
a geographical region portion identifying at least first and second geographical regions, wherein the first performance metric field presents a metric related to the service provided by the first supplier located in the first geographical region, and the second performance metric presents a metric related to a service provided by the second supplier located in the second geographical region.

53. The computer-readable medium of claim 50 wherein the time period field is configured to present a month.

54. The computer-readable medium of claim 50 wherein the performance metric field is configured to present a count of work product packages delivered to the at least one organization.

55. The computer-readable medium of claim 50 wherein the display page further comprises a chart containing work product package delivery data.

56. The computer-readable medium of claim 50 wherein the performance metric field is configured to present a dollar value related to invoices submitted for the at least one service provided for the at least one organization.
